(19) United States
(12) Patent Application Publication
(10) Pub. No.: US 2019/0283636 A1
(43) Pub. Date: Sep. 19, 2019

(54) VEHICLE AIR CONDITIONING SYSTEM

(71) Applicant: HONDA MOTOR CO., LTD., Tokyo (JP)

(72) Inventors: Yuichiro IMAIZUMI, Wako-shi (JP); Kazuhiko SEKI, Wako-shi (JP)

(21) Appl. No.: 16/277,399

(22) Filed: Feb. 15, 2019

(30) Foreign Application Priority Data
Mar. 19, 2018 (JP) 2018051393

(51) Int. Cl. B60N 2/56

(52) U.S. Cl. CPC B60N 2/5628

(57) ABSTRACT

A vehicle air conditioning system includes: a vehicle seat provided with a seat cushion having a side surface that is curved inward with respect to a widthwise direction as the side surface extends upward; an air conditioning unit configured to adjust a temperature of air and discharge temperature-adjusted air; and a blowing opening provided to open upward at a position along the side surface of the seat cushion and blowing the air discharged from the air conditioning unit.

### TECHNICAL FIELD

The present disclosure relates to a vehicle air conditioning system.

### BACKGROUND ART

JP2017-065601A discloses a vehicle seat including a seat cushion having a seating surface and support surfaces on both sides thereof, a seat back having a backrest surface and support surfaces on both sides thereof, and an air conditioning device which cools or heats the seating surface and support surfaces of the seat cushion and the backrest surface and support surfaces of the seat back with cool air or warm air from the inside of the seat cushion. In the vehicle seat disclosed in JP2017-065601A, support members provided on both sides of the seat cushion to define the support surfaces are integrally formed with respective armrests on upper ends thereof, and an air blowing opening is formed between each support surface and the corresponding armrest.

JP2015-083407A (also published as US2016/0272038A1) discloses a vehicle seat air conditioning device, which comprises a ventilator that blows air, an air blowout portion that is open so as to blow out the air blown by the ventilator toward a passenger sitting in a vehicle seat, a blowing direction changing portion disposed in the air blowout portion, the blowing direction changing portion changing a blowing direction of the air blown out from the air blowout portion, and a controller that causes the blowing direction changing portion to change the blowing direction based on passenger information including at least one of a build and a sitting position of the passenger. In this air conditioning device, the air blowout portion is arranged adjacent to the widthwise outer side of the seat cushion (FIG. 4) or in each of left and right peripheral portions of the upper surface of the seat cushion (FIG. 7).

JP2017-178275A also discloses a vehicle air conditioning device having blowing openings provided in left and right peripheral portions of an upper surface of a seat cushion, such that the conditioned air blown from the left and right blowing openings is directed obliquely upward toward the center of the seated occupant by louvers provided in each blowing opening such that the conditioned air flows along the thighs of the seated occupant to wrap around the lower body of the occupant.

In the invention disclosed in JP2017-178275A, by blowing the conditioned air from the blowing openings such that the air flows along the thighs of the seated occupant, it may be possible to warm or cool portions of the occupant that are not in contact with the seat. However, if the blowing openings are provided in the upper surface of the seat cushion, the blowing openings may be closed by the seated occupant. It may be possible to prevent the blowing openings from being closed by the occupant by providing the blowing openings on the outside of the seat cushion as shown in FIG. 4 of JP2015-083407A, but in such a case, in order to blow the conditioned air to flow along the thighs, it is necessary to provide a blowing direction changing means such as louvers in each blowing opening. Further, in the case where a blowing direction changing means is provided in each blowing opening, in order to blow the conditioned air to flow along the thighs, it is necessary to locate the blowing openings at a substantially same height as the side edge portions of the seating surface of the seat cushion, and the blowing openings can interfere with the occupant getting in and out of the seat. As in the invention disclosed in JP2017-065601A, in the case where the blowing openings are formed near the armrests, the armrests can similarly interfere with the occupant getting in and out of the seat.

### SUMMARY OF THE INVENTION

In view of such background, a primary object of the present invention is to provide a vehicle air conditioning system which can prevent the blowing opening from being closed by the seated occupant or from interfering with the occupant getting in and out of the vehicle seat, and can allow the conditioned air blown from the blowing opening to flow along the thigh of the seated occupant.

### Means to Accomplish the Task

To achieve the above object, an embodiment of the present invention provides a vehicle air conditioning system (20) comprising: a vehicle seat (10) provided with a seat cushion (11) having a side surface (11b) that is curved inward with respect to a widthwise direction as the side surface extends upward; an air conditioning unit (21) configured to adjust a temperature of air and discharge temperature-adjusted air; and a blowing opening (24S) provided to open upward at a position along the side surface of the seat cushion and blowing the air discharged from the air conditioning unit.

According to this arrangement, because the blowing opening is provided at a position along the side surface of the seat cushion, the blowing opening is not closed by the seated occupant, and does not hinder the occupant from getting in and out of the vehicle seat. On the other hand, because the blowing opening is provided to open upward and the side surface of the seat cushion is curved inward with respect to a widthwise direction as the side surface extends upward, the air blown upward from the blowing opening flows along the side surface of the seat cushion due to Coandă effect to thereby change its direction toward the widthwise center of the seat. Thereby, the air blown from the blowing opening flows along the thigh of the occupant seated on the seat cushion.

In the above arrangement, preferably, the blowing opening (24S) is formed in a slit shape extending in a fore and aft direction.

According to this arrangement, the air blown from the blowing opening can cover the entire length of the thigh of the occupant seated on the seat cushion.

In the above arrangement, preferably, the seat cushion (11) has left and right side surfaces (11b), and the blowing opening includes left and right blowing openings (24S) respectively provided along the left and right side surfaces of the seat cushion.

According to this arrangement, it is possible to cause the air blown from each of the left and right blowing openings to flow along the corresponding one of the left and right thighs of the occupant seated on the seat cushion. The airs flowing along the left and right thighs join together at or near the widthwise center of the vehicle seat and change the flowing direction to flow upward along the upper body of the occupant.

In the above arrangement, preferably, the air conditioning unit is configured to be capable of discharging warm air such that the warm air is blown from the blowing opening blowing opening (24S).

According to this arrangement, it is possible to effectively warm the thigh of the occupant seated on the seat cushion.

In the above arrangement, preferably, the air conditioning unit (21) is integrally provided in the vehicle seat (10).

According to this arrangement, it is unnecessary to provide an air conditioning duct to connect the vehicle body and the vehicle seat, and therefore, the duct of the vehicle air conditioning system can be simplified.

In the above arrangement, preferably, the vehicle air conditioning system further comprises a rectifying plate (26, 27) extending downward from the blowing opening (24S).

According to this arrangement, the conditioned air can be blown upward smoothly without being disturbed laterally or in the fore and aft direction.

In the above arrangement, preferably, the blowing opening (24S) is provided at a position lower than an upper edge of the side surface (11b) of the seat cushion (11), and more preferably, at a position lower than a vertically middle part of the side surface (11b) of the seat cushion (11).

According to this amendment, it is ensured more reliably that the blowing opening is not closed by the seated occupant, and does not hinder the occupant from getting in and out of the vehicle seat.

Thus, according to an embodiment of the present invention, it is possible to provide a vehicle air conditioning system which can prevent the blowing opening from being closed by the seated occupant or from interfering with the occupant getting in and out of the vehicle seat, and can allow the conditioned air blown from the blowing opening to flow along the thigh of the seated occupant.

### BRIEF DESCRIPTION OF THE DRAWINGS

FIG. 1 is a fragmentary longitudinal sectional view of an automobile equipped with a vehicle air conditioning system according to an embodiment of the present invention;

FIG. 2 is a perspective view of a vehicle seat shown in FIG. 1;

FIG. 3 is a sectional view taken along line III-III in FIG. 2; and

FIG. 4 is an explanatory diagram showing a flow of air in the vehicle air conditioning system according to the embodiment.

### DESCRIPTION OF THE PREFERRED EMBODIMENT(S)

In the following, an embodiment of the present invention will be described in detail with reference to the appended drawings.

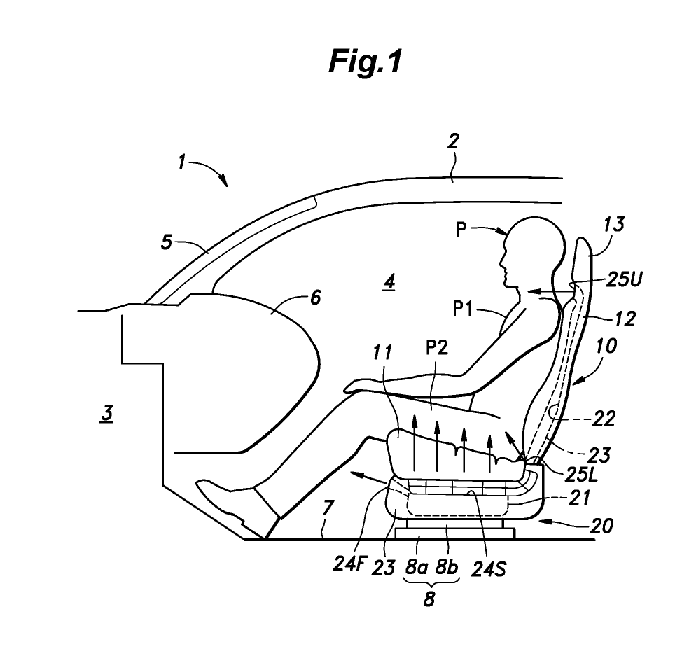

FIG. 1 is a fragmentary longitudinal sectional view of an automobile 1 equipped with a vehicle air conditioning system 20 according to an embodiment of the present invention. As shown in FIG. 1, the automobile 1 includes a vehicle body 2 having an engine room 3 defined in a front part thereof and a vehicle cabin (passenger compartment) 4 defined behind the engine room 3. It is to be noted that when the automobile is an electric car, the engine room 3 may contain an electric motor, a power control unit for controlling the electric motor, a heat exchange (radiator) for cooling the power control unit, etc. instead of an internal combustion engine. Also, in a case where multiple electric motors are used to individually drive the wheels of the automobile 1, the electric motors may be disposed near the respective wheels outside the engine room 3. Thus, the engine room 3 may or may not contain an engine or an electric motor therein.

A glass windshield 5 is provided on an upper front of the vehicle body 2, and a dashboard 6 projecting rearward from a lower end of the glass windshield 5 is provided in a front part of the vehicle cabin 4. Left and right vehicle seats 10 (only one of them is shown in FIG. 1) are arranged behind the dashboard 6 and mounted on a floor 7 of the vehicle body 2 via a slide mechanism 8 so as to be slidable in the fore and aft direction. The slide mechanism 8 includes left and right lower rails 8a extending in the fore and aft direction and fixed to the floor 7 and left and right upper rails 8b slidably engaging the corresponding lower rails 8a. The left and right vehicle seats 10 constitute a driver's seat and a passenger seat of the automobile 1, respectively. The dashboard 6 rearwardly overhangs the floor 7. As a space is formed below the dashboard 6, an occupant seated in each vehicle seat 10 (hereinafter referred to as a seated occupant P) can stretch the legs.

In the illustrated embodiment, only the left and right vehicle seats 10 are provided in the vehicle cabin 4 of the automobile 1, but the left and right vehicle seats 10 may constitute front seats and rear seats may be provided behind the front seats to constitute an additional row(s) of seats.

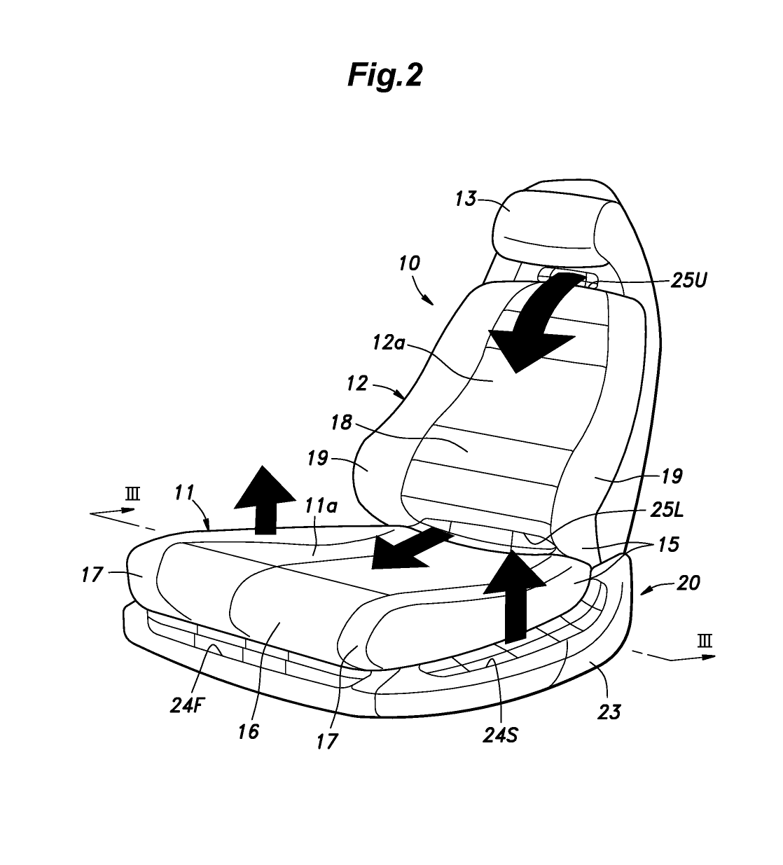

FIG. 2 is a perspective view of the vehicle seat 10 shown in FIG. 1. As shown in FIGS. 1 and 2, the vehicle seat 10 includes a seat cushion 11 fixed on the upper rail 8b of the slide mechanism 8 and a seat back 12 tiltably attached to a rear part of the seat cushion 11 via a reclining mechanism. A headrest 13 is integrally attached to an upper end of the seat back 12 so as to be positioned at a height corresponding to the head of the seated occupant P.

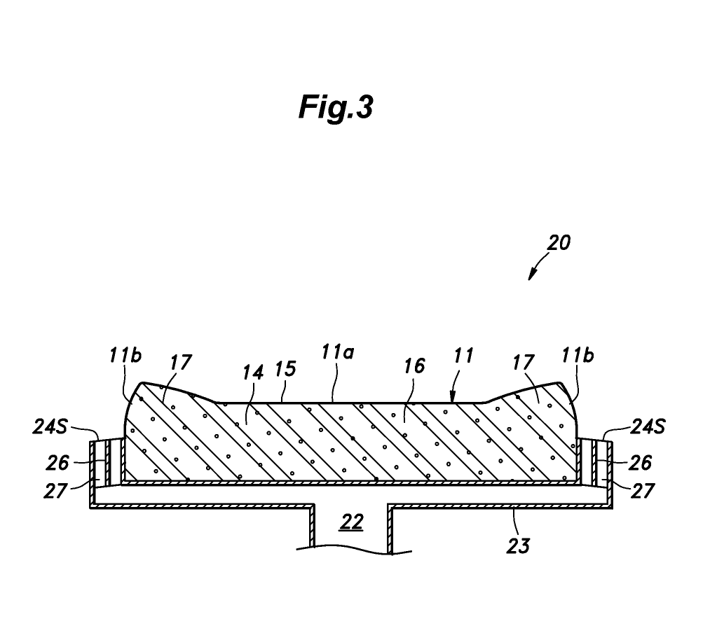

The seat cushion 11, the seat back 12, and the headrest 13 are formed of a metallic frame (not shown in the drawings), a cushioning material 14 (FIG. 3) covering the frame, and a skin or a cover 15 (FIG. 3) covering the cushioning material 14. The seat cushion 11 includes a cushion main part 16 located at a laterally central portion and left and right cushion side parts 17 provided on respective sides of the cushion main part 16 integrally with the cushion main part 16. The seat back 12 includes a back main part 18 located in a laterally central portion and left and right back support parts 19 provided on respective sides of the back main part 18 integrally with the back main part 18.

The vehicle air conditioning system 20 provided in the automobile 1 conditions air in the vehicle cabin 4. The vehicle air conditioning system 20 includes an air conditioning unit 21 integrally provided in the vehicle seat 10 under the seat cushion 11. The air conditioning unit 21 adjusts the temperature of the air and sends the temperature-adjusted air to an air flow passage 22 defined in the vehicle seat 10. The flow passage 22 is defined by air conditioning ducts 23 provided in the seat back 12 and the seat cushion 11 of the vehicle seat 10.

The air conditioning unit 21 may be a known heating ventilation air conditioning (HVAC) system that performs heating, ventilation, and air conditioning in the vehicle cabin 4. In the present embodiment, the air conditioning unit 21 has heating and cooling functions.

The air sent to the flow passage 22 is blown toward the seated occupant P from seat blowing openings (not shown in the drawings) consisting of multiple small holes formed in a backrest surface 12a of the seat back 12 and a seating surface 11 a of the seat cushion 11. Thus, the vehicle air conditioning system 20 provides a seat air conditioning function in that the conditioned air is directly blown to the seated occupant P from the seat blowing openings formed in the vehicle seat 10 such that portions of the seated occupant P contacting the seat are directly heated or cooled and/or ventilation is performed.

In addition, the air sent to the flow passage 22 is also blown toward the seated occupant P from cushion blowing openings 24 (24L, 24U) formed on lateral sides of the seat cushion 11 and seat back blowing openings 25 (25F, 25S) formed on a periphery of the seat back 12. Thus, the vehicle air conditioning system 20 provides localized cooling and heating for the seated occupant P by blowing the conditioned air directly to the seated occupant P from the blowing openings (24, 25) formed in the vehicle seat 10.

The cushion blowing openings 24 includes a cushion front part blowing opening 24F formed on a front lower edge of the seat cushion 11 and left and right cushion side part blowing openings 24S formed on respective sides of the seat cushion 11. The cushion front part blowing opening 24F opens forward. The cushion side part blowing openings 24S open upward.

The seat back blowing openings 25 include a seat back lower blowing opening 25L provided between the seat cushion 11 and the seat back 12 and a seat back upper blowing opening 25U formed between the seat back 12 and the headrest 13. The seat back lower blowing opening 25L opens obliquely forward and upward. The seat back upper blowing opening 25U opens forward.

Flow path switching dampers (not shown in the drawings) are provided in the air conditioning unit 21 and the flow passage 22, and a controller of the air conditioning unit 21 controls the flow path switching dampers to switchably select the blowing openings to which the temperature-adjusted air is sent. For instance, during cooling, the controller of the air conditioning unit 21 controls the flow path switching dampers to send the conditioned air to the seating surface 11a of the seat cushion 11, the backrest surface 12a of the seat back 12, and the seat back blowing openings 25 (25L, 25U). During heating, the controller of the air conditioning unit 21 controls the flow path switching dampers to send the conditioned air to the seating surface 11a of the seat cushion 11, the backrest surface 12a of the seat back 12, the seat back lower blowing opening 25L, and the cushion blowing openings 24 (cushion front part blowing opening 24F and cushion side part blowing openings 24S).

Also, during cooling, the controller of the air conditioning unit 21 may preferably control the flow path switching dampers such that the cushion blowing openings 24 (24F, 24S) function as air inlets for admitting air from the vehicle cabin 4 and feeding the admitted air to the air conditioning unit 21 to produce the conditioned air. During heating, the controller of the air conditioning unit 21 may preferably control the flow path switching dampers such that the seat back upper blowing opening 25U function as an air inlet.

The conditioned air (cool air or warm air) blown from the seat back lower blowing opening 25L cools or warms the hip and waist of the seated occupant P. The conditioned air (cool air) blown from the seat back upper blowing opening 25U cools the neck of the seated occupant P and flows downward on the front side of the upper body P1 of the seated occupant P to cool the upper body P1 and the thighs P2 of the seated occupant P. The conditioned air (warm air) blown from the cushion front part blowing opening 24F warms the lower legs (feet) of the seated occupant P. The conditioned air (warm air) blown from the cushion side part blowing openings 24S warms the thighs P2 of the seated occupant P. In the following, the structure of the cushion side part blowing openings 24S and the advantageous effects provided thereby will be described.

FIG. 3 is a sectional view taken along line in FIG. 2. As shown in FIG. 3, the seating surface 11 a of the seat cushion 11 forms a support surface that extends substantially horizontally in the lateral direction at the cushion main part 16 and extends obliquely upward and outward with respect to the seat at each cushion side part 17. The thickness of each cushion side part 17 increases toward the outer edge of the seat such that the cushion side part 17 has the largest thickness on the outer edge (side edge) of the seat. Left and right side surfaces 11b of the seat cushion 11 each extend substantially vertically in a lower part thereof and are curved inward with respect to a widthwise direction as the side surface extends upward in an upper part thereof.

Each of the cushion side part blowing openings 24S is provided at a position along a corresponding one of the left and right side surfaces 11b of the seat cushion 11 or at a position lower than the upper edge of the corresponding side surface 11b (more specifically, at a position lower than a vertically middle part of the corresponding side surface 11b of the seat cushion 11). Thus, a part of each side surface 11b of the seat cushion 11 located higher than the cushion side part blowing opening 24S is curved inward with respect to the widthwise direction as the side surface 11b extends upward.

As shown in FIG. 3, the air conditioning duct 23 for conducting air to the left and right sides of the seat extends horizontally under the seat cushion 11 and is curved upward at either lateral end portion thereof to have two vertically extending end portions on the respective sides of the seat cushion 11. Each of the left and right cushion side part blowing openings 24S is formed in an upper surface of the corresponding one of the end portions of the air conditioning duct 23, where the upper surface of each end portion of the air conditioning duct 23 is slanted downward toward the outside. Each end portion of the air conditioning duct 23 defines a downstream portion of the flow passage 22 such that the downstream portion of the flow passage 22 is directed upward; namely, each cushion side part blowing opening 24S opens upward (or opens to blow the conditioned air upward). As shown in FIG. 2, each cushion side part blowing opening 24S is formed in a slit shape extending in the fore and aft direction along the corresponding side surface 11b of the seat cushion 11.

Each end portion of the air conditioning duct 23 is integrally provided with a first rectifying plate 26 and multiple second rectifying plates 27. The first rectifying plate 26 extends vertically and in the fore and aft direction to divide the corresponding downstream portion of the flow passage 22 forming the cushion side part blowing opening 24S into left and right portions. The second rectifying plates 27 each extend vertically and laterally to divide the corresponding downstream portion of the flow passage 22 into multiple portions arranged in the fore and aft direction. Thereby, the conditioned air that has changed its flowing direction from the horizontal direction to the upward direction along each curved end portion of the air conditioning duct 23 can be blown upward from the cushion side part blowing opening 24S without being disturbed laterally or in the fore and aft direction.

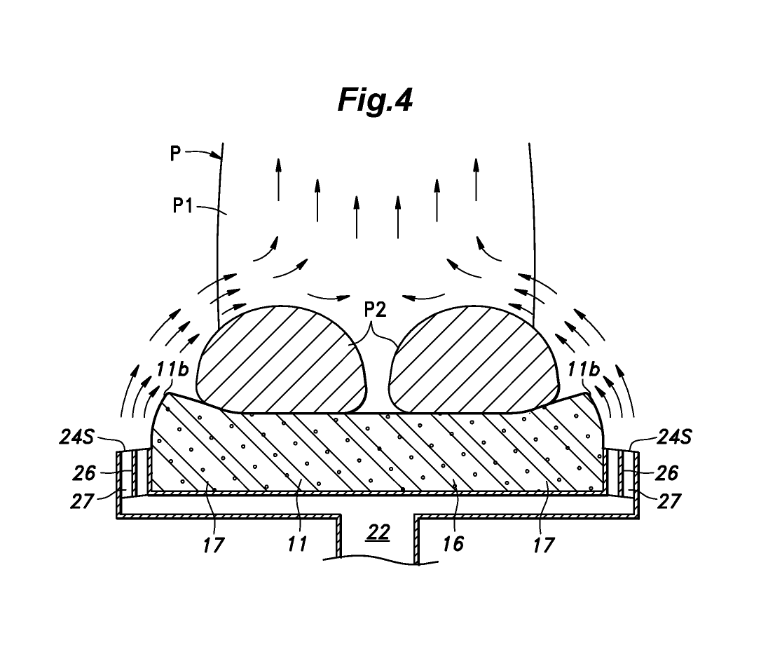

As described above, in the illustrated embodiment, each side surface 11b of the seat cushion 11 is curved inward with respect to the widthwise direction as the side surface 11b extends upward, and each cushion side part blowing opening 24S is provided to open upward at a position along the corresponding side surface 11b of the seat cushion 11, and therefore, the conditioned air (typically, warm air) blown from the cushion side part blowing openings 24S flows as shown by arrows in FIG. 4. That is, the conditioned air blown upward from each of the left and right cushion side part blowing openings 24S flows along the corresponding side surface 11b of the seat cushion 11 due to Coandă effect, and because the side surface 11b of the seat cushion 11 is curved widthwise inward as the side surface 11b extends upward, the flowing direction of the blown air is changed toward the widthwise center of the seat. The seating surface 11a of the seat cushion 11 supports thereon the left and right thighs P2 of the seated occupant P. The conditioned air flowing along each side surface 11b of the seat cushion 11 toward the widthwise center of the seat flows along the corresponding thigh P2 of the seated occupant P and warms an upper part of the thigh P2 (a part not in contact with the seat cushion 11). The conditioned airs flowing along the respective thighs P2 of the seated occupant P join together at or near the widthwise center of the seat and change the flowing direction to flow upward along the upper body P1 of the seated occupant P.

In addition, because the cushion side part blowing openings 24S are each formed in a slit shape extending in the fore and aft direction, the air blown from the cushion side part blowing openings 24S can cover the entire length of the thighs P2 of the seated occupant P, whereby the thighs P2 of the seated occupant P is warmed effectively.

Further, because the left and right cushion side part blowing openings 24S are provided along the left and right side surfaces 11b of the seat cushion 11, respectively, the airs flowing along the left and right thighs P2 join together at or near the widthwise center of the vehicle seat 10 and change the flowing direction to flow upward along the upper body P1 of the seated occupant P. Thereby, the upper body P1 of the seated occupant P also can be warmed effectively by the conditioned air.

Thus, by blowing the warm air produced by the air conditioning unit 21 from the cushion side part blowing openings 24S, the thighs P2 and the upper body P1 of the seated occupant P can be warmed effectively.

In addition, because the cushion side part blowing openings 24S are each provided at a position along the corresponding side surface 11b of the seat cushion 11, the cushion side part blowing openings 24S are not closed by the seated occupant P and do not interfere with the occupant getting in and out of the vehicle seat 10.

In the present embodiment, the air conditioning unit 21 is integrally provided in the vehicle seat 10, it is not necessary to provide an air conditioning duct to connect the vehicle body 2 and the vehicle seat 10, and therefore, the duct structure of the vehicle air conditioning system 20 can be simplified.

A concrete embodiment of the present invention has been described in the foregoing, but the present invention is not limited to the embodiment and may be modified or altered in various ways. For example, in the above embodiment, the vehicle air conditioning system 20 according to the present invention was applied to the front seat of the automobile 1, but the vehicle air conditioning system 20 may be the rear seat. Further, in the above embodiment, the air conditioning unit 21 has a cooling function and a heating function, but the air conditioning unit 21 may have only one of the cooling function and the heating function. The concrete structure, arrangement, number, material, etc. of the component parts of the embodiment may be appropriately changed within the scope of the present invention. Also, not all of the structural elements shown in the above embodiment are necessarily indispensable and they may be selectively used as appropriate.

1. A vehicle air conditioning system, comprising:
a vehicle seat provided with a seat cushion having a side surface that is curved inward with respect to a widthwise direction as the side surface extends upward;
an air conditioning unit configured to adjust a temperature of air and discharge temperature-adjusted air; and
a blowing opening provided to open upward at a position along the side surface of the seat cushion and blowing the air discharged from the air conditioning unit.

2. The vehicle air conditioning system according to claim 1, wherein the blowing opening is formed in a slit shape extending in a fore and aft direction.

3. The vehicle air conditioning system according to claim 1, wherein the seat cushion has left and right side surfaces, and the blowing opening includes left and right blowing openings respectively provided along the left and right side surfaces of the seat cushion.

4. The vehicle air conditioning system according to claim 1, wherein the air conditioning unit is configured to be capable of discharging warm air such that the warm air is blown from the blowing opening.

5. The vehicle air conditioning system according to claim 1, wherein the air conditioning unit is integrally provided in the vehicle seat.

6. The vehicle air conditioning system according to claim 1, further comprising a rectifying plate extending downward from the blowing opening.

7. The vehicle air conditioning system according to claim 1, wherein the blowing opening is provided at a position lower than an upper edge of the side surface of the seat cushion.

8. The vehicle air conditioning system according to claim 7, wherein the blowing opening is provided at a position lower than a vertically middle part of the side surface of the seat cushion.
